(19) United States
(12) Patent Application Publication
(10) Pub. No.: US 2003/0016777 A1
(43) Pub. Date: Jan. 23, 2003

(54) TIG welded MOX fuel rod

(76) Inventors: Alain Vandergheynst, Dour (BE); Louis Aerts, Mol (BE); Jean Heylen, Mol (BE)

Correspondence Address: SUGHRUE, MION, ZINN, MACPEAK & SEAS, PLLC, 2100 Pennsylvania Avenue, N.W., Washington, DC, 20037-3213, US

(21) Appl. No.: 09/906,801

(22) Filed: Jul. 18, 2001

(51) Int. Cl. G21C 3/10

(52) U.S. Cl. 376/451

(57) ABSTRACT

A welded MOX fuel rod having a cladding and an end plug joined by a circumferential weld, the weld bead being designed to affect equivalent masses in both the cladding and end plug.

### FIELD OF THE INVENTION

This invention relates to a welded MOX nuclear fuel rod having a cladding and an end plug joined by a circumferential weld. MOX fuel is a Mixed OXide fuel comprised of uranium and plutonium oxides.

### BACKGROUND OF THE INVENTION

A fuel rod for nuclear reactors consists essentially of a column of fuel pellets in a tube, called cladding, with leak-tight plugs at both ends. Fuel pellets stacked in the cladding are usually made of UO₂ or MOX. TIG (Tungsten Inert Gas) welding is the most commonly utilized technique for attaching the end plugs to a cladding tube in the fabrication of nuclear fuel rods. This weld is usually called a “girth weld”. Fuel rods for light water reactors, pressurized (PWR) or boiling (BWR), are currently internally pre-pressurized. This pre-pressurization is realized through an axial or a radial hole in the upper end plug, the hole being thereafter sealed by welding. Only the girth weld geometry will be considered hereafter.

As known, the cladding abuts against an annular shoulder of the upper end plug, and the cladding and end plug have the same external diameter at least where they are welded.

Imperfections in the manufacturing of these welds are recognized as the most frequent cause of fabrication related fabrication-related failure or leakage of fuel rods in the operation of nuclear power plants. While the resulting proportion of leaking fuel rods does not affect the safety of nuclear power plants, it is an economic penalty and an embarrassment for the plant operator. Moreover, even benign and acceptable failures of MOX fuel rods attract media attention, with a resulting overemphasis of such events, and with negative impact on public acceptance of nuclear power plants.

Elimination of weld defects has therefore attracted great attention and has led to various alternative welding techniques capable of minimizing the occurrence of defects generally occurring in TIG welds. Such alternative welding techniques are, for instance, electron beam welding, laser beam welding, magnetic force welding and resistance welding.

The two mentioned beam techniques require more sophisticated equipment than required for TIG welding. Such equipment is therefore less robust and not easy to maintain and service in the restricted access conditions of a MOX fuel fabrication plant. Furthermore, while these techniques may minimize the occurrence of weld defects, they do not eliminate the cause of the defects. Additionally, electron beam welding requires operation under a vacuum. Drawing a vacuum on MOX fuel rods can cause ejection of Pu contaminated dust through the bore hole of the cladding and contamination of the whole equipment. Magnetic force welding and resistance welding present the disadvantage of producing protruding weld seams, and the protruding part of the weld needs to be machined away to maintain the fuel rod within outer diameter tolerances. Machining a variable part of weld is required, but reduces the original extent of the welded zone. Furthermore, machining potentially Pu-contaminated material is considered undesirable.

In all welding techniques, the most frequent imperfections are a lack of penetration of the weld, and the occurrence of porosities due to the degassing of the metals being joined together by the weld and due to the trapping of the gaseous atmosphere under which the welding operation is conducted. This trapping is of course eliminated if the welding is conducted under a vacuum, as is the case for electron beam welding and can be the case for laser welding.

To minimize importance and reduce occurrence of defects, a common approach has been taken by industry in designing the upper end plug of a fuel rod: a cylindrical surface tightly fitted to the inner diameter of the cladding, and a perfectly orthogonal land surface fitted to the perfectly orthogonal machined end of the cladding. FIGS. 1 and 2 illustrate the most common design of such end plugs for, respectively, PWR and BWR fuel rods.

The tightly mating surfaces between the end plug and cladding are deemed essential to achieve a good weld penetration in both the cladding and the end plug, and to minimize porosities in the welds. While tight fitting is an advantage for the ability to be fabricated, it is a disadvantage for quality control, which is most commonly performed by X-ray radiography. The X-rays are, indeed, unable to differentiate a welded zone from perfectly mating non-welded surfaces. Furthermore, the X-rays have to traverse a material thickness up to ten times the cladding thickness and detect therein porosities with a dimension threshold of only a small fraction of the cladding thickness. The quality control sensitivity is therefore reduced. A robust quality control with reduced handling requirements is particularly important when more highly radioactive fuel, such as MOX fuel, is to be manufactured.

Two additional disadvantages are being encountered in the standard end plug welding approach:

the reentrant right angle between the mating cylindrical and land surfaces of the end plug cannot be machined without clearance. Moreover, quality control to verify the tip of this reentrant angle for burrs and squareness is difficult to be carried out under industrial mass production conditions. If machining of the end plug does not meet the required precision, curling out of the cladding end is observed, and the welding is adversely affected. It is known that chamfering the inner diameter of the cladding end can obviate such a defect, but the reduced cladding thickness weakens the mechanical characteristics of the welds, and

in PWR fuel rods, the heat capacity of the end plug is much greater than the heat capacity of the cladding, due to the difference in masses subjected to the striking arc (or beam). It is known that positioning the arc (or beam) impact slightly off the cladding-plug junction line, towards the plug, can compensate for this difference in heat capacity. This remedy leads, however, to variance of distribution of heat between plug and cladding, with a resulting variance of the mating contact between the two parts to be welded.

Those three disadvantages affect the quality of industrial welds, more specifically the weld penetration and the occurrence of porosities. For MOX fuels, the resulting rejects, reworks and quality control operations are particularly penalizing and impact on fabrication costs and radioactive exposure of personnel.

BWR end plugs seem to minimize some of the disadvantages, by adopting a corner weld between the end plug and cladding, resulting in a weld geometry in which the weld-affected zone is more evenly distributed between the end plug and the cladding, but such a corner position of the weld makes the weld more vulnerable to mechanical damage upon further handling of the fuel rod. In MOX fuel, the friction between such corner welds and the grid structure can cause abrasion of the weld zone and release of Pu-contamination originally trapped in the weld.

If the weld affected zones are very different in mass, the welding arc (or beam) intensity must be adjusted to the most massive zone. As a result, the intensity is higher than if the zones were equivalent in mass, thereby inducing two unfavorable results

a more abundant outgassing of the volatile constituents of the cladding and end plug alloys. As such volatile constituents in the alloys are designed to improve the behavior under irradiation, the weakest points of fuel rods become the weld-affected zones, in which quality control is the most difficult to achieve, especially under the manufacturing conditions of MOX fuel, and

a greater energy dissipation in the end plug than in the cladding. It induces differences in the cooling kinetics and causes cooling down micro-cracks. The penetrating micro-cracks are detected by the leak test which is part of the fuel rod quality control. It results in (expensive) fabrication rejects. Most micro-cracks are not penetrating, but can develop into through-cracks under stresses generated during reactor operation, with, as a consequence, leaking fuel rods.

### SUMMARY OF THE INVENTION

To provide for ideal welding conditions of MOX fuel rods, the weld should be in a lateral position as in FIG. 1 and not on a corner like in FIG. 2. However, the weld-affected zone should be equally subdivided between cladding and end plug, as approximated in FIG. 2, and not as depicted in FIG. 1.

To this end, according to the present invention, in a welded fuel rod as described above to define the field of the invention, the weld bead is realized in a way that it affects equivalent masses in both the cladding and the end plug.

In one embodiment of the invention, the equivalent weld-affected masses are achieved by a circumferential chamber machined in the end plug.

In another embodiment of the invention, a gas pressure equilibration between said chamber and the inner volume of the cladding is realized by means of a longitudinal channel machined in the tight fitting area between the end plug and the cladding bore.

According to the invention, TIG welding is preferred between the cladding and the end plug.

The invention is advantageously applied to MOX fuel rods and also to other Pu-bearing fuel rods.

Zirconium alloys are currently used for both cladding and end plug, for LWR fuel rods.

In one embodiment of the invention, the cladding and the end plug are made of stainless steel or other ferrous or non-ferrous high temperature alloys.

Advantageously, the invention may be embodied in fuel rods designed for PWRs or VVERs or BWRs as well for fast reactors. (VVER is an acronym for “Vodo-Vodyannoy Energeticheskiy Reactor”).

Other details and particular features of the invention will emerge from the appended claims and the description of the invention, given below by way of non-limiting examples, with reference to the appended drawings.

### BRIEF DESCRIPTION OF THE DRAWINGS

FIG. 1 is a schematic axial cross-section of a conventional PWR weld between cladding and end plug.

FIG. 2 is a schematic axial cross-section of a conventional BWR weld between cladding and end plug.

FIG. 3 is a schematic axial cross-section of a weld according to the invention.

FIG. 4 is a schematic axial cross-section similar to FIG. 3, the end plug being however equipped with a longitudinal channel.

FIG. 5 is a schematic transverse cross-section taken along the line V-V of FIG. 4.

In the various figures, the same references denote the same or similar elements.

### DETAILED DESCRIPTION OF THE INVENTION

A fuel rod of the invention comprises a cladding 1 and an upper end plug 2 assembled by a circumferential weld 3. The cladding 1 abuts against an annular shoulder 4 of the end plug 2. Cladding 1 and end plug 2 have the same external diameter, at least where they are welded together. An opposite end plug (not shown) may be welded with the same technique.

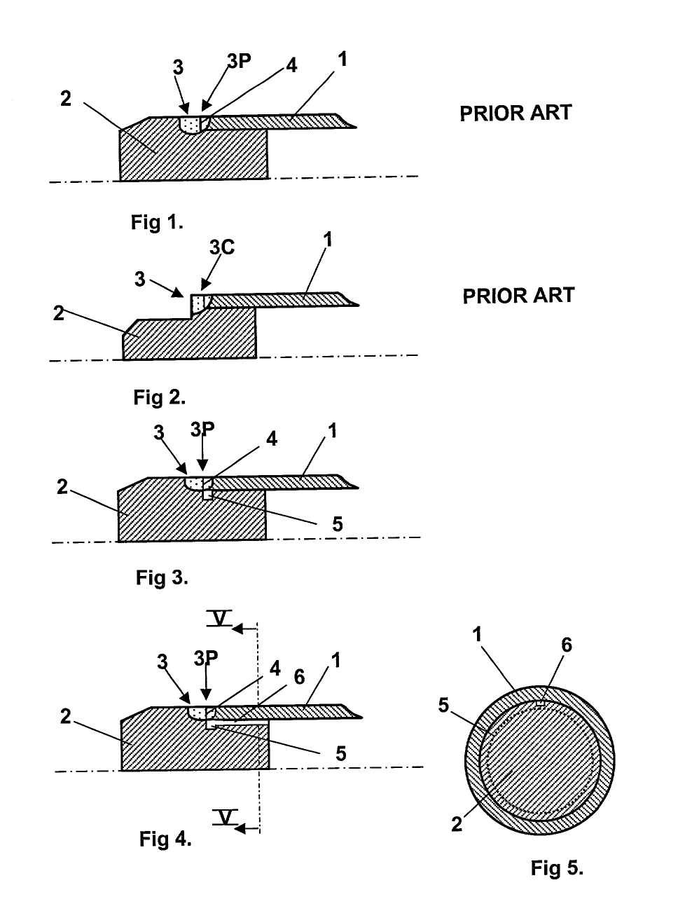

To avoid the inconveniences inherent in the weld configurations illustrated in FIGS. 1 and 2, a new weld configuration has been developed (FIG. 3). In this new configuration, the benefit of a peripheral weld 3P (FIGS. 1 and 3) over a corner weld 3C (FIG. 2) is maintained, but a part of the end plug mass (FIG. 3) normally affected by the weld 3 is eliminated. This is realized by machining a circular chamber 5 out of the end plug 2. The advantages of a peripheral weld 3P as in FIG. 1 and of a more balanced weld-affected zone in cladding 1 and end plug 2 as in FIG. 2 are maintained accordingly. Over those two previous weld configurations, this new configuration of the invention presents the additional advantage of not being influenced by the precision and quality of machining reentrant angles in the end plug 2.

As a fringe benefit, should be mentioned an enhanced precision and sensitivity of X-ray testings of the weld 3. Indeed, the X-rays penetrate a reduced thickness of plug material, whereby the signal from porosities is less attenuated, and smaller porosities become detectable.

The preferred shape or cross-section of the above mentioned chamber 5 is rectangular, as illustrated in FIG. 3, as it maximizes the unnecessary plug volume taken away and maximizes thereby sensitivity of the X-ray testing, but any other shape of chamber 5 can be considered and provides the above mentioned benefits.

In the version of the invention described up to here, a diametrical clearance must be maintained between the reentrant part of the plug 2 and the bore of the cladding 1. During the welding operation, the gaseous atmosphere in the chamber 5 increases in temperature, and the resulting increase in pressure must be compensated by an axial gas flow from the chamber 5 to the inside of cladding 1.

By lack of communication between the chamber 5 and the main inner volume of the cladding 1, the gas pressure inside the chamber 5 would blow out the liquid weld bead 3, which would result in a weld defect. Due to this loose fitting of the plug 2 inside the cladding 1, the axial alignment of the plug 2 can be effected only by high precision machining of the flat end of the cladding 1 and the mating circumferential flat surface area or shoulder 4 of the plug 2. High precision machining of the flat area 4 of the plug 2 is facilitated by the larger extent of this area as compared to usual end plugs 2 (FIGS. 1 and 2) and by not having to care for defects at the tip of the reentrant angle. However, this perfect axial fitting is somewhat difficult to maintain during the welding operation. The progression of the weld zone along the circumference during welding induces local thermal deformations. Experienced operators and properly designed welding equipment succeed, however, to produce a welded fuel rod with properly aligned weld plug 2.

It must be understood that the present invention is in no way limited to the embodiments described above and that many modifications may be carried out thereon without departing from the scope of the claims presented below.

Thus, a further improvement of the invention for a more reliable weld consists of machining a longitudinal channel 6 in the circumferential fitting area of the end plug 2, to connect the circumferential chamber 5 to the inner volume of the cladding 1 (FIG. 4). The fit between end plug diameter and inner cladding bore can then be tight, as in standard end plug configurations. The axial alignment of welded end plug 2 and cladding 1 is thereby greatly facilitated.

While this invention has been developed to cope with the specific requirements of LWR MOX fuel rods, it can, of course, be applied to any MOX fuel rod and more generally to any nuclear fuel.

What is claimed is:

1. A welded MOX nuclear fuel rod comprising a cladding and an end plug joined by a circumferential weld, characterized by a weld bead which affects equivalent masses in both the cladding and the end plug, respectively.

2. The welded fuel rod according to claim 1, further comprising a circumferential chamber machined in the end plug to form the equivalent weld-affected masses.

3. The welded fuel rod according to claim 2, further comprising a longitudinal channel machined in a tight fitting area between the end plug and a bore of the cladding, in order to improve a gas pressure equilibration between the chamber and an inner volume of the cladding.

4. The welded fuel rod according to claim 1 or 2, wherein the weld is formed by TIG welding.

5. The welded fuel rod according to claim 1 or 2, wherein Pu-bearing fuel other than MOX fuel is enclosed in the fuel rod.

6. The welded fuel rod according to claim 1 or 2, wherein the cladding and the end plug are made of Zirconium alloy.

7. The welded fuel rod according to claim 1 or 2, wherein the cladding and the end plug are made of stainless steel or other ferrous or non-ferrous high temperature alloys.

8. A method of welding a cladding of a nuclear fuel rod to an end plug of the fuel rod, comprising the step of providing, between the fuel weld and the end plug, a weld bead of equivalent masses of the cladding and the end plug.

9. The method according to claim 8, further comprising the step of machining a circumferential chamber in the end plug to form the equivalent weld-affected masses.

10. A method according to claim 9, further comprising the step of machining a longitudinal channel in a tight-fitting area between the end plug and a bore of the cladding, in order to improve a gas pressure equilibration between the chamber and an inner volume of the cladding.
